(19) United States
(12) Patent Application Publication
(10) Pub. No.: US 2018/0075780 A1
(43) Pub. Date: Mar. 15, 2018

(54) TRAINING ASSISTANCE APPARATUS

(71) Applicant: JTEKT Corporation, Osaka-shi (JP)

(72) Inventors: Toshiyuki Tsuzuki, Anjo-shi (JP); Toshio Aono, Chiryu-shi (JP)

(73) Assignee: JTEKT CORPORATION, Osaka-shi (JP)

(21) Appl. No.: 15/700,508

(22) Filed: Sep. 11, 2017

(30) Foreign Application Priority Data
Sep. 13, 2016 (JP) 2016-178994

(51) Int. Cl. G09B 25/02; G07C 3/00; G07C 3/04; G09B 19/24

(52) U.S. Cl. CPC G09B 25/02; G09B 19/24; G07C 3/04; G07C 3/005

(57) ABSTRACT

A training assistance apparatus includes an actual operation time acquiring unit configured to acquire an actual operation time of an operation that is executed by an operator on a processing machine, a standard time storing unit configured to store a standard time of the operation, and a display unit configured to display the actual operation time and the standard time for comparison.

### INCORPORATION BY REFERENCE

The disclosure of Japanese Patent Application No. 2016-178994 filed on Sep. 13, 2016 including the specification, drawings and abstract, is incorporated herein by reference in its entirety.

### BACKGROUND OF THE INVENTION

### 1. Field of the Invention

The present invention relates to a training assistance apparatus.

### 2. Description of the Related Art

Operation capacities of processing machines (for example, machine tools or industrial robots) vary depending on operators. In particular, unskilled operators and skilled operators have a remarkable difference in their operation abilities. It is therefore desired that unskilled operators be trained so that the unskilled operators can complete operations within a standard operation time at an early stage.

Japanese Patent Application Publication No. 2014-178449 (JP 2014-178449 A) describes a training assistance apparatus that contributes to efficient training of operators according to situations. The training assistance apparatus includes an ability information acquiring unit configured to acquire ability information on abilities of one, two, or more operators, an operation history acquiring unit configured to acquire operation history information on operation histories of one, two, or more operators, an operation request history acquiring unit configured to acquire operation request history information on operation requests from one, two, or more customers, and a training priority determining unit configured to determine training priority of contents of training for each operator based on the ability information, the operation history information, and the operation request history information.

Japanese Patent Application Publication No. 2006-133443 (JP 2006-133443 A) describes a training course navigation system configured to provide necessary training curricula according to individual abilities. This system navigates optimum training plans by displaying training curricula important to the trainees based on personal information, training information, and weighting information obtained by attributes of organization or the like.

In the training of unskilled operators, it is important to grasp the ability levels of the unskilled operators. It is also important for the unskilled operators to feel that their skill levels are improved.

### SUMMARY OF THE INVENTION

It is one object of the present invention to provide a training assistance apparatus capable of improving operation abilities of unskilled operators.

A training assistance apparatus according to one aspect of the present invention includes an actual operation time acquiring unit configured to acquire an actual operation time of an operation that is executed by an operator on a processing machine, a standard time storing unit configured to store a standard time of the operation, and a display unit configured to display the actual operation time and the standard time for comparison.

With this configuration, the operator can grasp whether the operation executed by the operator is standard. By grasping a result of the comparison, the operator can have an opportunity to find a motivation to improve the operation ability.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a layout diagram of a facility of an embodiment of the present invention;

FIG. 2 is a diagram illustrating the internal configuration of the facility;

FIG. 3A is a diagram illustrating an operation procedure and display contents at the start of operation on an operator's terminal (home terminal, portable terminal, or operator's panel) in FIG. 2;

FIG. 3B is a diagram illustrating an operation procedure and display contents at the completion of operation on the operator's terminal (home terminal, portable terminal, or operator's panel) in FIG. 2;

FIG. 4 is a diagram illustrating the configuration of a management apparatus illustrated in FIG. 1 and FIG. 2;

FIG. 5 is a diagram illustrating contents to be displayed on a display device in FIG. 4, including initial process schedules, process results, and updated process schedules (planned tasks);

FIG. 6 is a diagram illustrating operation result information of operators, which is stored in an ability database in FIG. 4;

FIG. 7 is a flowchart illustrating processing to be performed by a subsequent operation determining unit in FIG. 4;

FIG. 8 is a diagram illustrating the configuration of a training assistance apparatus illustrated in FIG. 2;

FIG. 9A is a diagram illustrating a first example of display contents to be displayed on a display unit illustrated in FIG. 8;

FIG. 9B is a diagram illustrating a second example of the display contents to be displayed on the display unit illustrated in FIG. 8; and

FIG. 9C is a diagram illustrating a third example of the display contents to be displayed on the display unit illustrated in FIG. 8.

### DETAILED DESCRIPTION OF EMBODIMENTS

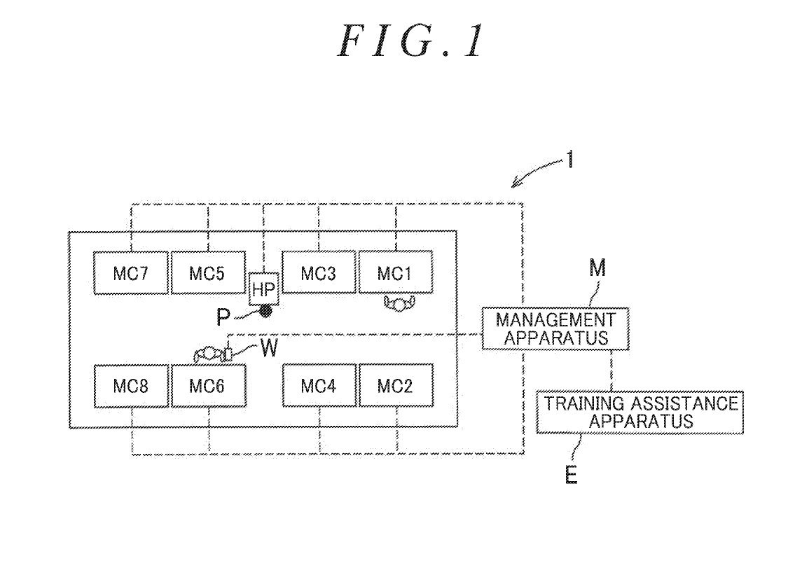

The configuration of a facility 1 is described with reference to FIG. 1. The facility 1 is, for example, a production facility for producing various objects, or a physical distribution facility for transporting objects. In this embodiment, a production facility for machining objects is taken as an example of the facility 1. The facility 1 is a non-fully automated facility where operators work. That is, processing to be executed by processing machines MC1 to MC8 constituting the facility 1 is not completely automated in the facility 1, but the operators are required to operate the processing machines MC1 to MC8.

As illustrated in FIG. 1, the facility 1 includes eight processing machines MC1 to MC8, a home terminal HP, a plurality of portable terminals W, a management apparatus M, and a training assistance apparatus E. The object to be produced is, for example, a cylindrical member.

The processing machines MC1 to MC8 are, for example, machine tools such as a machining center, a lathe, and a grinding machine. The order from the processing machine MC1 to the processing machine MC8 corresponds to the order of process steps. The processing machines MC1 to MC8 are arranged in two rows. The processing machines MC1 to MC8 in the respective rows are arranged with their front sides facing each other.

The processing machines MC1 to MC8 are arranged in order from a lathe configured to execute rough machining of an outer profile, a grinding machine configured to execute semi-finishing of the outer profile, a lathe configured to execute rough machining of an inner profile, a grinding machine configured to execute semi-finishing of the inner profile, a grinding machine configured to execute finishing of a straight portion of the outer profile, a grinding machine configured to execute finishing of a tapered portion of the outer profile, a grinding machine configured to execute finishing of a straight portion of the inner profile, and a grinding machine configured to execute finishing of a tapered portion of the inner profile.

The home terminal HP is installed at a home position P in the facility 1. The home position P is a reference position in the facility 1, and is defined from the viewpoint of operations. The home terminal HP is an apparatus for assigning an operation to an operator and allowing the operator to input operation start information and operation completion information. The operator inputs information on the home terminal HP every time an operation is started or completed. From the viewpoint of an operator's moving range, the home position P where the home terminal HP is installed is set near the center of the entire facility 1. The home position P where the home terminal HP is installed is not limited to the position near the center of the facility 1, but is determined as appropriate depending on the arrangement of the processing machines MC1 to MC8 constituting the facility 1.

The portable terminal W is a terminal that has the same functions as those of the home terminal HP and can be carried by an operator. That is, the portable terminal W is a device for assigning an operation to an operator and allowing the operator to input operation start information and operation completion information. The type of the portable terminal W may be a hand-held type or a wearable type. Examples of the hand-held type include a tablet, a mobile phone, a smartphone, and other unwearable devices. Examples of the wearable type include an arm band type, a glasses type, an earphone type, and a helmet-mounted type.

Any one of the home terminal HP and the portable terminal W may selectively be used because the home terminal HP and the portable terminal W have the same functions. When both of the home terminal HP and the portable terminal W are used, for example, an unskilled operator is allowed to use only the home terminal HP, and a skilled operator is allowed to use both of the home terminal HP and the portable terminal W. As described later, when the portable terminal W is used, an operation time is estimated as one element of an operation ability, and thus the operation ability of the operator cannot be grasped accurately. Therefore, it is appropriate that the operator be allowed to use the portable terminal W when the operation ability of the operator is stable to some extent, that is, when the operator is skilled.

The management apparatus M manages processing to be executed by the processing machines MC1 to MC8 and operations to be executed by operators on the processing machines MC1 to MC8. Specifically, the management apparatus M has functions of grasping utilization results, creating updated process schedules, assigning subsequent operations to operators, and constructing an ability database of operators. The management apparatus M is connected to the processing machines MC1 to MC8 and the home terminal HP via a wired or wireless communication network. The management apparatus M is connected to the portable terminals W via a wireless communication network.

The training assistance apparatus E is an apparatus for training unskilled operators by using information stored in the management apparatus M. In particular, the training assistance apparatus E displays, for example, information to be used for the unskilled operators to grasp their operation abilities, and information to be used for comparison between operations executed by the unskilled operators and operations executed by the skilled operators.

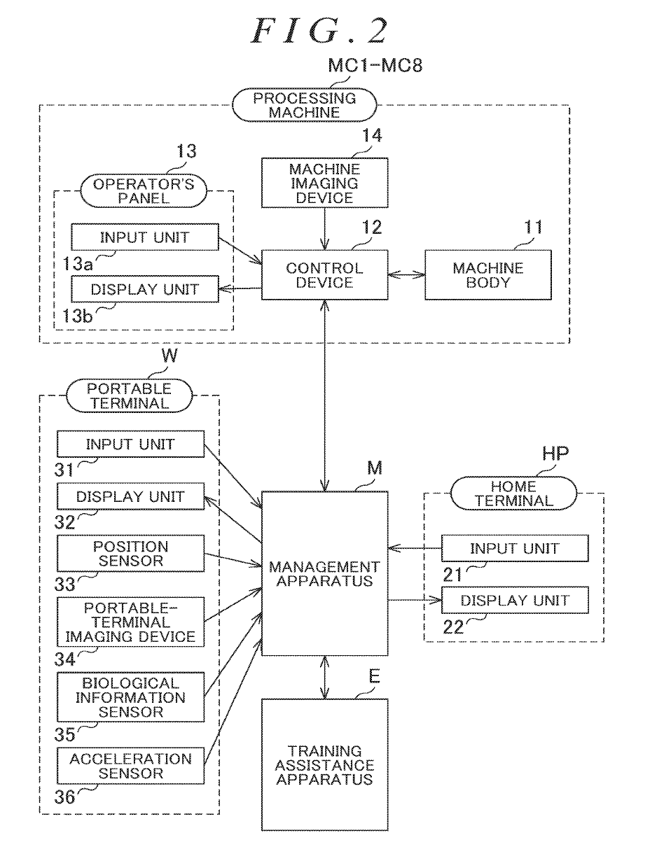

Next, the internal configurations of the processing machines MC1 to MC8, the home terminal HP, and the portable terminal W are described with reference to FIG. 2.

Each of the processing machines MC1 to MC8 includes a machine body 11, a control device 12, an operator's panel 13, and a machine imaging device 14. The operator's panel 13 includes an input unit 13a and a display unit 13b. The machine imaging device 14 is a device for imaging the surroundings of each of the processing machines MC1 to MC8, in particular, imaging operator's motion.

The home terminal HP includes an input unit 21 and a display unit 22. The portable terminal W includes an input unit 31, a display unit 32, a position sensor 33, a portable-terminal imaging device 34, a biological information sensor 35, and an acceleration sensor 36. The position sensor 33 of the portable terminal W is a sensor for recognizing the position of the portable terminal W in the facility 1. For example, the position sensor 33 is a GPS sensor. The portable-terminal imaging device 34 images an operator's visual field. The biological information sensor 35 detects operator's pulse and respiration waves. The acceleration sensor 36 detects signals corresponding to operator's motion (for example, walking or standing state).

The input unit 13a of the operator's panel 13, the input unit 21 of the home terminal HP, and the input unit 31 of the portable terminal W are, for example, touch panels on which information can be input by touch operation, or mechanical buttons.

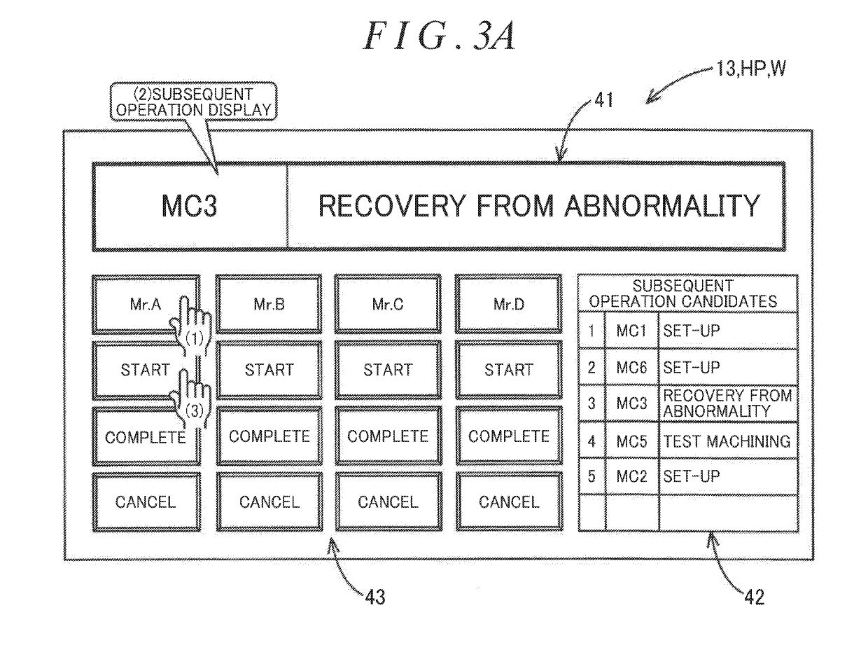

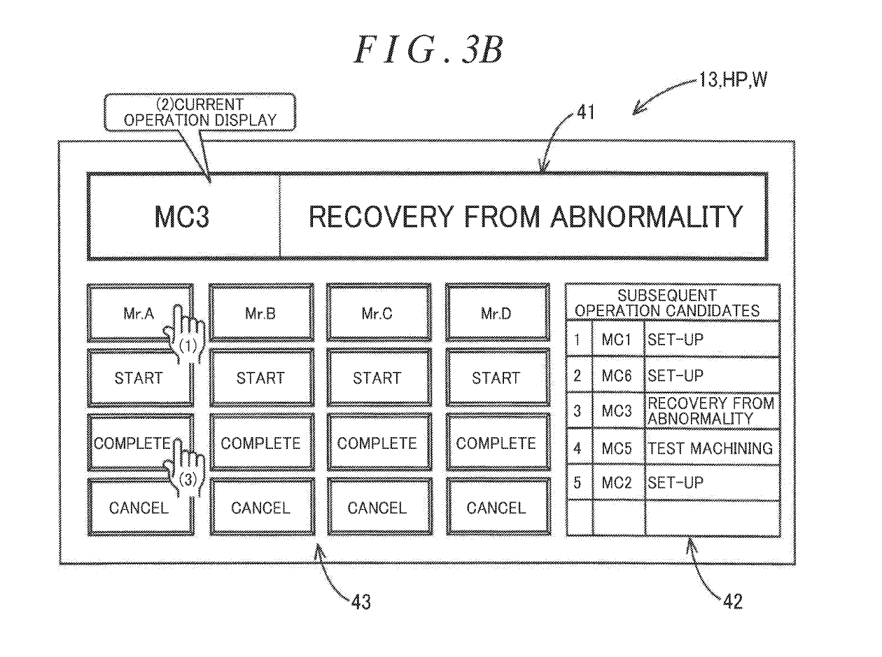

Each of the operator's panel 13, the home terminal HP, and the portable terminal W is an apparatus or device for providing an instruction to an operator and allowing the operator to input information. Therefore, the operator's panel 13, the home terminal HP, and the portable terminal W are hereinafter referred to collectively as operator's terminal 13, HP, W. The configuration of the operator's terminal 13, HP, W is described with reference to FIG. 3A and FIG. 3B.

As illustrated in FIG. 3A and FIG. 3B, the operator's terminal 13, HP, W has an operation display field 41 for displaying a subsequent or current operation, a candidate field 42 for displaying a list of subsequent operation candidates, and an input field 43 for displaying operator's name buttons and start buttons, completion buttons, and cancellation buttons for operations of the respective operators.

The operation display field 41 displays one of the processing machines MC1 to MC8 to be operated and an operation category. The operation display field 41 functions as a field for assigning a subsequent operation to an operator who intends to start the subsequent operation as illustrated in FIG. 3A, and also as a field for displaying a current operation for an operator who intends to complete the current operation as illustrated in FIG. 3B.

The candidate field 42 displays operations that can currently be executed by an operator (hereinafter referred to as subsequent operation candidates). The candidate field 42 displays the processing machines MC1 to MC8 to be operated and the operation categories. The candidate field 42 also displays priority levels when a plurality of subsequent operation candidates is displayed.

Next, an operation procedure to be followed by an operator when the operator starts a subsequent operation is described with reference to FIG. 3A. The candidate field 42 of the operator's terminal 13, HP, W constantly displays subsequent operation candidates that can be executed currently. An operator who is not currently executing any operation touches his/her operator's name button on the operator's terminal 13, HP, W (indicated by (1) in FIG. 3A). Then, the operation display field 41 of the operator's terminal 13, HP, W displays a subsequent operation (indicated by (2) in FIG. 3A). This subsequent operation is one of the subsequent operation candidates displayed in the candidate field 42. That is, the operator's terminal 13, HP, W assigns the subsequent operation to the operator. Then, the operator starts the assigned subsequent operation by touching the start button (indicated by (3) in FIG. 3A).

Next, an operation procedure to be followed by an operator when the operator completes a current operation is described with reference to FIG. 3B. An operator who completes an operation on one of the processing machines MC1 to MC8 touches his/her operator's name button on the operator's terminal 13, HP, W (indicated by (1) in FIG. 3B). Then, the operation display field 41 of the operator's terminal 13, HP, W displays the current operation (indicated by (2) in FIG. 3B). That is, the operator can view the current operation in the operation display field 41. Then, the operator completes the current operation by touching the completion button (indicated by (3) in FIG. 3B) or based on, for example, a signal from one of the processing machines MC1 to MC8.

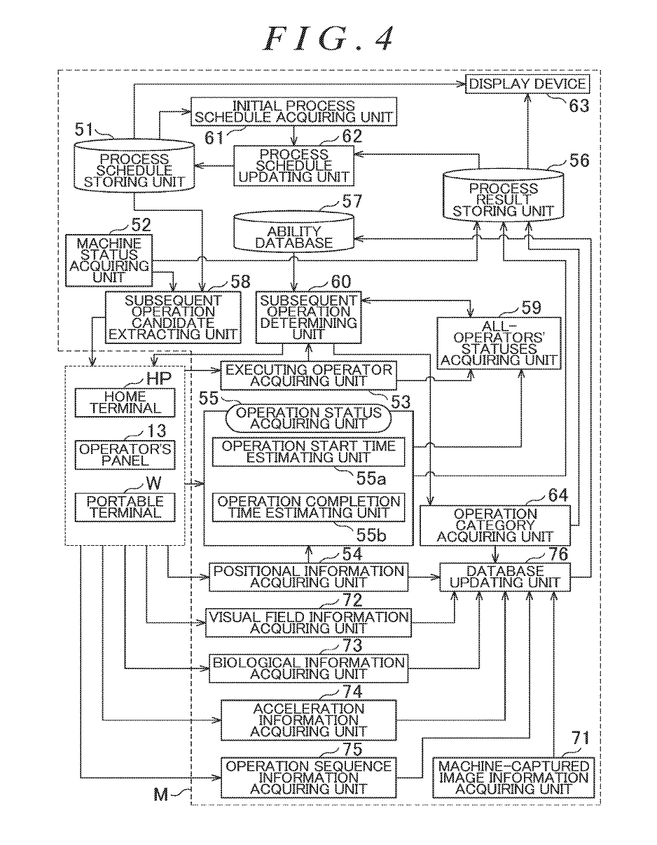

Next, an overview of the management apparatus M is described with reference to FIG. 4. As illustrated in FIG. 4, the management apparatus M includes a process schedule storing unit 51, a machine status acquiring unit 52, an executing operator acquiring unit 53, a positional information acquiring unit 54, an operation status acquiring unit 55, a process result storing unit 56, an ability database 57, a subsequent operation candidate extracting unit 58, an all-operators' statuses acquiring unit 59, a subsequent operation determining unit 60, an initial process schedule acquiring unit 61, a process schedule updating unit 62, a display device 63, an operation category acquiring unit 64, a machine-captured image information acquiring unit 71, a visual field information acquiring unit 72, a biological information acquiring unit 73, an acceleration information acquiring unit 74, an operation sequence information acquiring unit 75, and a database updating unit 76.

Among the units constituting the management apparatus M, the machine status acquiring unit 52 acquires information on current statuses (utilization statuses) of the processing machines MC1 to MC8 from the control devices 12 of the processing machines MC1 to MC8. The machine-captured image information acquiring unit 71 acquires information on images captured by the machine imaging devices 14 of the processing machines MC1 to MC8. The executing operator acquiring unit 53, the positional information acquiring unit 54, the operation status acquiring unit 55, the visual field information acquiring unit 72, the biological information acquiring unit 73, the acceleration information acquiring unit 74, and the operation sequence information acquiring unit 75 acquire information on an executing operator, positional information, information on an operation status, visual field information, biological information, acceleration information, and operation sequence information from the operator's terminal 13, HP, W, respectively.

The executing operator acquiring unit 53 acquires, as information on an executing operator, information on an operator corresponding to an operator's name button that is touched on the operator's terminal 13, HP, W. That is, the executing operator acquiring unit 53 acquires ID information of an operator who executes an operation (operator's name or the like). The other units constituting the management apparatus M perform processing in the management apparatus M, and are described later in detail.

As described above, the management apparatus M has the functions of grasping utilization results, creating updated process schedules, assigning subsequent operations to operators, and constructing an ability database of operators. The function of grasping utilization results is implemented by the process schedule storing unit 51, the machine status acquiring unit 52, the positional information acquiring unit 54, the operation status acquiring unit 55, the process result storing unit 56, the display device 63, and the operation category acquiring unit 64.

The function of creating updated process schedules is implemented by the process schedule storing unit 51, the process result storing unit 56, the initial process schedule acquiring unit 61, and the process schedule updating unit 62. The function of assigning subsequent operations to operators is implemented by the process schedule storing unit 51, the machine status acquiring unit 52, the executing operator acquiring unit 53, the positional information acquiring unit 54, the operation status acquiring unit 55, the ability database 57, the subsequent operation candidate extracting unit 58, the all-operators' statuses acquiring unit 59, and the subsequent operation determining unit 60.

The function of constructing an ability database of operators is implemented by the ability database 57, the positional information acquiring unit 54, the operation category acquiring unit 64, the machine-captured image information acquiring unit 71, the visual field information acquiring unit 72, the biological information acquiring unit 73, the acceleration information acquiring unit 74, the operation sequence information acquiring unit 75, and the database updating unit 76.

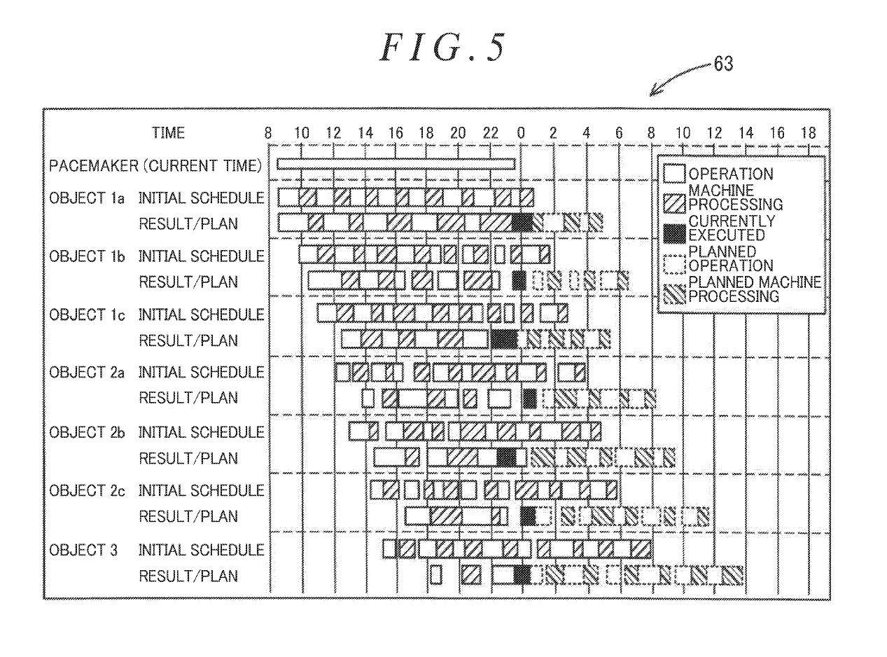

The function of grasping utilization results by the management apparatus M is described with reference to FIG. 4 and FIG. 5. First, an initial process schedule, a process result, and an updated process schedule to be used for the function of grasping utilization results are described with reference to FIG. 5.

FIG. 5 is a diagram illustrating contents to be displayed on the display device 63. FIG. 5 illustrates a pacemaker indicating a current time, initial process schedules for respective objects, which are stored in the process schedule storing unit 51, updated process schedules for the respective objects, which are stored in the process schedule storing unit 51, and process results for the respective objects, which are stored in the process result storing unit 56. Objects 1a, 1b, and 1c are objects of the same type, and objects 2a, 2b, and 2c are objects of the same type. The object refers to an object to be produced (workpiece, assembly, or the like) in the case of a production facility, and an object to be distributed (object to be transported) in the case of a physical distribution facility. The objects 1a, 1b, and 1c, the objects 2a, 2b, and 2c, and an object 3 are objects of different types.

The process schedule refers to a schedule that defines execution sequence of processing to be executed by each of the plurality of processing machines MC1 to MC8 and operations to be executed by an operator on each of the plurality of processing machines MC1 to MC8. The initial process schedule and the updated process schedule are stored in the process schedule storing unit 51. The initial process schedule is determined in advance by a manager based on production planning for each object. The initial process schedule refers to a process schedule that is set based on an operation time of an operator having a standard operation ability (standard time). The updated process schedule refers to a process schedule that is obtained by updating the initial process schedule based on a utilization result of the processing machine and an operation result of the operator. The process result indicates a processing result of each of the processing machines MC1 to MC8 and an operation result of the operator. The process result is stored in the process result storing unit 56.

In FIG. 5, the pacemaker indicates that the current time is about 23:30. The initial process schedule is displayed in an initial schedule field of each object in FIG. 5. In the initial schedule field, a hollow box enclosed by a continuous line represents an operation to be executed by an operator, and a hatched box enclosed by a continuous line represents processing to be executed by one of the processing machines MC1 to MC8.

In a result/plan field of each object in FIG. 5, the process result corresponds to hollow boxes enclosed by continuous lines and hatched boxes enclosed by continuous lines. In the result/plan field, the hollow box enclosed by the continuous line represents an operation result of the operator, and the hatched box enclosed by the continuous line represents a processing result of one of the processing machines MC1 to MC8. In the result/plan field of each object in FIG. 5, the updated process schedule corresponds to hollow boxes enclosed by dashed lines and hatched boxes enclosed by dashed lines. The hollow box enclosed by the dashed line represents a planned operation to be executed by the operator, and the hatched box enclosed by the dashed line represents planned processing to be executed by one of the processing machines MC1 to MC8. In FIG. 5, a solid box represents processing that is currently executed by one of the processing machines MC1 to MC8 or an operation that is currently executed by the operator. A space between boxes represents a time period in which none of the processing machines MC1 to MC8 or operators executes processing or an operation.

The process result storing unit 56 stores the processing results of the processing machines MC1 to MC8 and the operation results of the operators. The processing result of each of the processing machines MC1 to MC8 is information acquired by the machine status acquiring unit 52. The machine status acquiring unit 52 acquires a current status (utilization status) of each of the processing machines MC1 to MC8 from the control device 12 of each of the processing machines MC1 to MC8.

The operation result of each of the operators is information acquired by the operation status acquiring unit 55 and the operation category acquiring unit 64. The operation status acquiring unit 55 acquires information on an operation status of an operator as one element of the operation result. The information on an operation status of an operator refers to information indicating an operation start time, an operation completion time, and whether the operation is in progress or completed.

When the home terminal HP is operated, the operation status acquiring unit 55 uses a start time and a completion time input on the home terminal HP as the start time and the completion time. When the portable terminal W is operated, the operation status acquiring unit 55 estimates a start time and a completion time that would be input on the home terminal HP without using a start time and a completion time input on the portable terminal W. That is, the operation status acquiring unit 55 estimates the start time and the completion time to be input at the home position P based on the start time and the completion time input on the portable terminal W and a distance between a current position and the home position P.

The operation category acquiring unit 64 acquires an operation category that is executed by the operator as the other element of the operation result. The operation category acquiring unit 64 acquires the operation category by acquiring a subsequent operation determined by the subsequent operation determining unit 60 described later. Details of the processing to be performed by the operation status acquiring unit 55 and the processing to be performed by the subsequent operation determining unit 60 are described later.

Next, the function of creating updated process schedules by the management apparatus M is described with reference to FIG. 4 and FIG. 5. The function of creating updated process schedules is implemented by the process schedule storing unit 51, the process result storing unit 56, the initial process schedule acquiring unit 61, and the process schedule updating unit 62.

The initial process schedule acquiring unit 61 acquires an initial process schedule stored in the process schedule storing unit 51. The process schedule updating unit 62 creates an updated process schedule as represented by the boxes enclosed by the dashed lines in FIG. 5 based on the initial process schedule acquired by the initial process schedule acquiring unit 61 and a process result stored in the process result storing unit 56.

The process schedule updating unit 62 acquires the initial process schedule from the initial process schedule acquiring unit 61. When the result stored in the process result storing unit 56 is updated, the process schedule updating unit 62 updates the process schedule based on the process result. That is, when the process result shows a delay in the initial process schedule, the process schedule updating unit 62 determines a future process schedule in consideration of the delay. At this time, the operation time of the operator is set based on an operation time of an operator having a standard operation ability.

Next, description is given of the ability database 57 that is used for the function of assigning subsequent operations to operators by the management apparatus M. The ability database 57 stores an operation ability of each operator for each operation category for a plurality of operators and a plurality of operation categories. Examples of the operation category include processes such as set-up, test machining, and recovery from abnormality. Each information is stored for each of the processing machines MC1 to MC8.

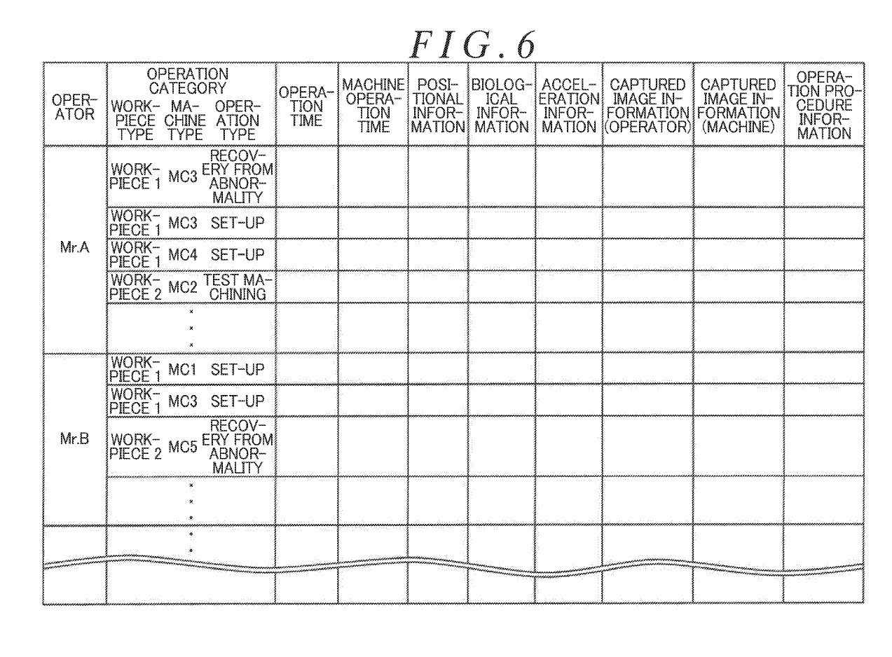

The ability database 57 has operation result information illustrated in FIG. 6. The operation result information includes, for each operator and operation category, an operation time, a machine operation time, positional information, biological information, acceleration information, visual field information indicated by an image captured by the portable-terminal imaging device 34, information indicated by an image captured by the machine imaging device 14, and operation procedure information. The operation time refers to a time from the start to completion of an operation with the home position P set as a reference. The machine operation time refers to a time during which an operation is executed directly on each of the processing machines MC1 to MC8. The machine operation time can be obtained based on, for example, an operation on the operator's panel 13, positional information, machine-captured image information, visual field information, and acceleration information. The operation procedure information refers to information on an operation procedure followed by an operator on the operator's panel 13.

As described above, the ability database 57 has a large number of pieces of operation result information. The ability database 57 is constructed by the database updating unit 76. That is, the database updating unit 76 updates the ability database 57 by acquiring information from the positional information acquiring unit 54, the operation category acquiring unit 64, the machine-captured image information acquiring unit 71, the visual field information acquiring unit 72, the biological information acquiring unit 73, the acceleration information acquiring unit 74, and the operation sequence information acquiring unit 75. When operations are executed a plurality of times for the same object, the latest information is stored.

Description is given on the processing to be performed by the all-operators' statuses acquiring unit 59 that is used for the function of assigning subsequent operations to operators by the management apparatus M. The all-operators' statuses acquiring unit 59 receives information on an executing operator acquired by the executing operator acquiring unit 53 and operation statuses acquired by the operation status acquiring unit 55. Specifically, the all-operators' statuses acquiring unit 59 has, for each operator, an input time of operation start information, an estimated time of the start of an operation with the home position P set as a reference, an input time of operation completion information, and an estimated time of the completion of the operation with the home position P set as a reference.

The all-operators' statuses acquiring unit 59 also has information on whether an operator is executing or has completed an operation. The all-operators' statuses acquiring unit 59 determines that the operator is executing the operation when the operation is not completed after the start of the operation, and that the operator has completed the operation when there is no operation started after the completion of that operation.

The all-operators' statuses acquiring unit 59 also has a predicted time of completion of an assigned operation by an operator who is executing the operation. At this time, the all-operators' statuses acquiring unit 59 acquires an operation category assigned to the operator from the subsequent operation determining unit 60, thereby calculating the predicted time in consideration of a standard operation time associated with the operation category.

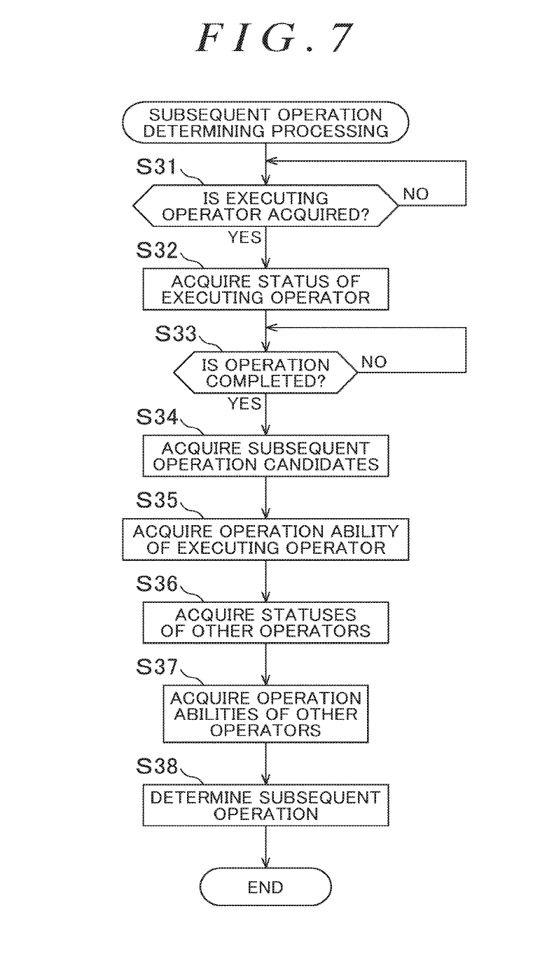

Next, the function of assigning subsequent operations to operators by the management apparatus M is described with reference to FIG. 3A, FIG. 4, and FIG. 7. The function of assigning subsequent operations to operators is implemented by the process schedule storing unit 51, the machine status acquiring unit 52, the executing operator acquiring unit 53, the positional information acquiring unit 54, the operation status acquiring unit 55, the ability database 57, the subsequent operation candidate extracting unit 58, the all-operators' statuses acquiring unit 59, and the subsequent operation determining unit 60.

As illustrated in FIG. 4, the subsequent operation candidate extracting unit 58 acquires current statuses of the plurality of processing machines MC1 to MC8, which are acquired by the machine status acquiring unit 52, and a process schedule stored in the process schedule storing unit 51. Then, the subsequent operation candidate extracting unit 58 extracts candidates for a subsequent operation to be executed by an operator based on the current statuses of the processing machines MC1 to MC8 and the process schedule. The subsequent operation candidates are operations that currently require operators in the entire facility 1. The subsequent operation candidates are displayed in the candidate field 42 of the operator's terminal 13, HP, W in FIG. 3A. When the subsequent operation candidate extracting unit 58 extracts a plurality of subsequent operation candidates, priority levels are determined for the plurality of subsequent operation candidates. The priority levels are also displayed in the candidate field 42 in FIG. 3A.

Next, the subsequent operation determining unit 60 determines a subsequent operation for a predetermined operator. The processing to be performed by the subsequent operation determining unit 60 is described with reference to FIG. 7. The subsequent operation determining unit 60 determines whether an executing operator is acquired from the executing operator acquiring unit 53 (S31). That is, when any operator touches the operator's name button on the operator's terminal 13, HP, W, the subsequent operation determining unit 60 determines that the executing operator is acquired.

When the executing operator is not acquired, the subsequent operation determining unit 60 does not advance the processing (S31: No). When the executing operator is acquired (S31: Yes), the subsequent operation determining unit 60 acquires a status of the executing operator from the all-operators' statuses acquiring unit 59 (S32). Then, the subsequent operation determining unit 60 determines whether the executing operator has completed an operation (S33). When the operation is not completed (S33: No), the subsequent operation determining unit 60 returns to S33 to repeat the processing.

When the operation is completed (S33: Yes), the subsequent operation determining unit 60 acquires the subsequent operation candidates extracted by the subsequent operation candidate extracting unit 58 (S34). Then, the subsequent operation determining unit 60 acquires an operation ability of the executing operator from the ability database 57 (S35). Then, the subsequent operation determining unit 60 acquires statuses of the other operators from the all-operators' statuses acquiring unit 59 (S36). For example, the subsequent operation determining unit 60 acquires statuses as to whether any other operator is currently ready to start a subsequent operation or whether any other operator is about to complete an operation. Then, the subsequent operation determining unit 60 acquires operation abilities of the other operators from the ability database 57 (S37).

Finally, the subsequent operation determining unit 60 determines a subsequent operation for the executing operator based on the subsequent operation candidates, the operation ability of the executing operator, the statuses of the other operators, and the operation abilities of the other operators (S38). The subsequent operation determining unit 60 determines whether the executing operator can execute a subsequent operation candidate having a higher priority level, and determines an executable subsequent operation candidate as a subsequent operation for the executing operator. When any other operator is also ready to start an operation, the subsequent operation determining unit 60 determines a subsequent operation for the executing operator in consideration of the operation ability of the executing operator and the operation abilities of the other operators.

For example, suppose an operator A can execute all operation categories, and operators B, C, and D can execute only some operation categories. In a case of determining a subsequent operation for the operator A, suppose the operator B is currently ready to start a subsequent operation or is about to become ready to start a subsequent operation. When a subsequent operation candidate having a higher priority level is set as an operation category that can be executed by both of the operator A and the operator B, the subsequent operation determining unit 60 determines a subsequent operation candidate having a lower priority level as a subsequent operation for the operator A. The subsequent operation candidate having a higher priority level may not be able to be assigned as a subsequent operation for the operator B, but the subsequent operation candidate having a lower priority level cannot be assigned as a subsequent operation for the operator B in some cases. Therefore, the subsequent operation candidate having a higher priority level is determined as a subsequent operation for the operator B, and the subsequent operation candidate having a lower priority level is determined as a subsequent operation for the operator A. As a result, the subsequent operation candidates can be executed efficiently.

When the subsequent operation candidate having a lower priority level is determined as a subsequent operation, the process schedule is taken into consideration. When the process schedule may be delayed as a result of determining the subsequent operation candidate having a lower priority level as a subsequent operation for an operator, the subsequent operation candidate having a higher priority level is determined as a subsequent operation for the operator instead of determining the subsequent operation candidate having a lower priority level as a subsequent operation for the operator.

As long as the process schedule is not delayed, the subsequent operation determining unit 60 may determine a subsequent operation for an operator having a lower operation ability level than a standard ability level. In FIG. 5, a space between boxes represents a time period in which none of the processing machines MC1 to MC8 or operators executes processing or operation. That is, the subsequent operation determining unit 60 may utilize this idle time to make an allowance by setting a longer operation time than a standard operation time. In this manner, the operator having a lower operation ability level can be trained.

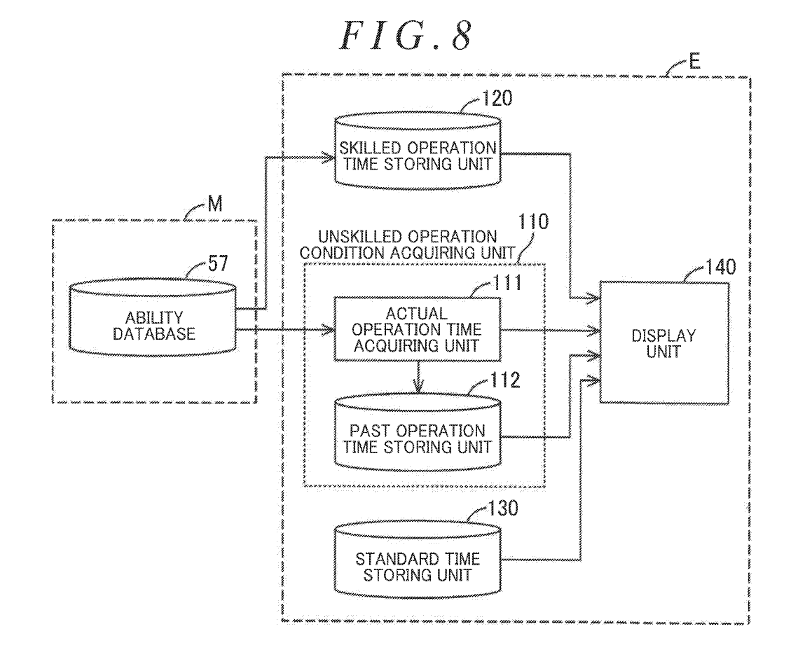

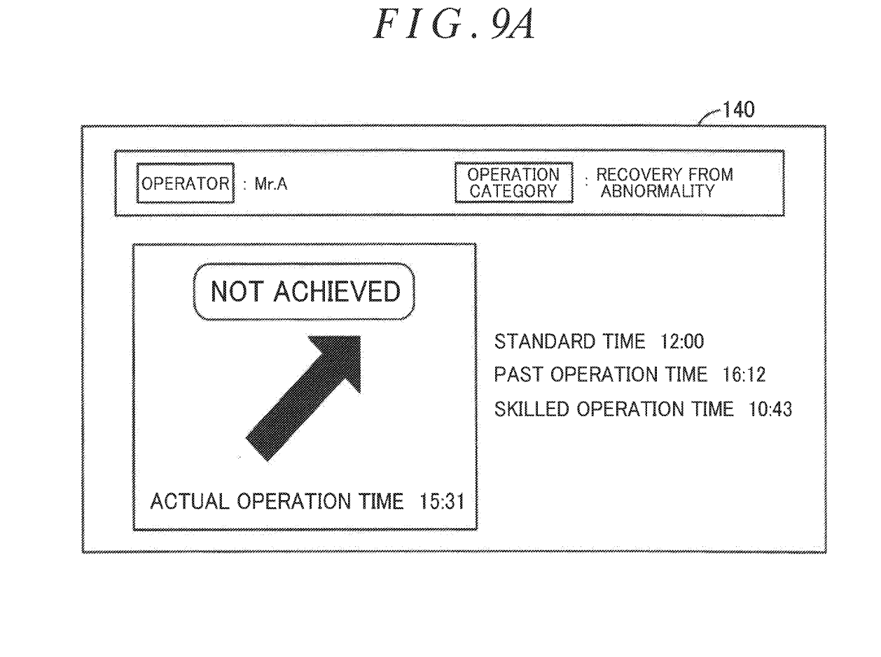

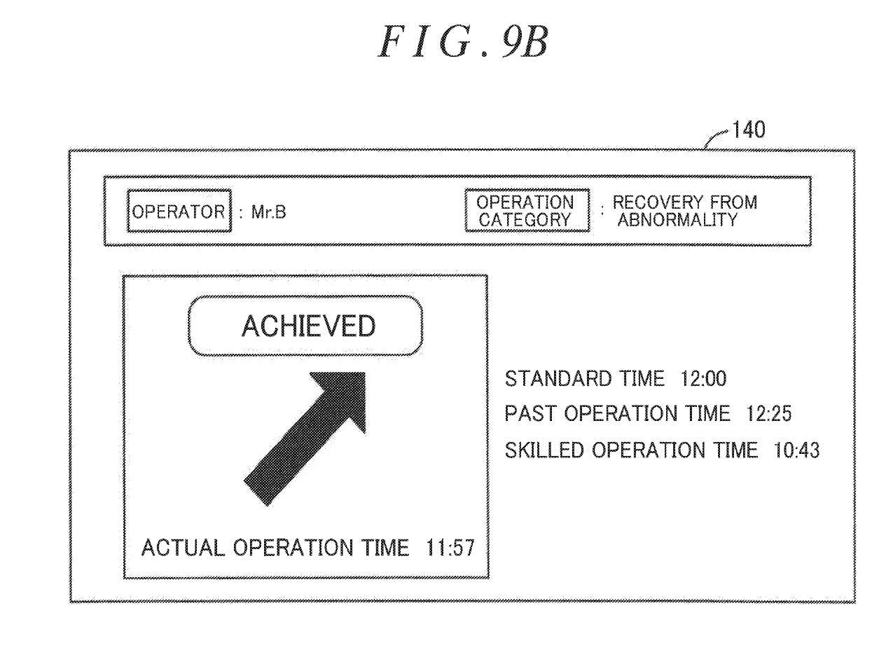

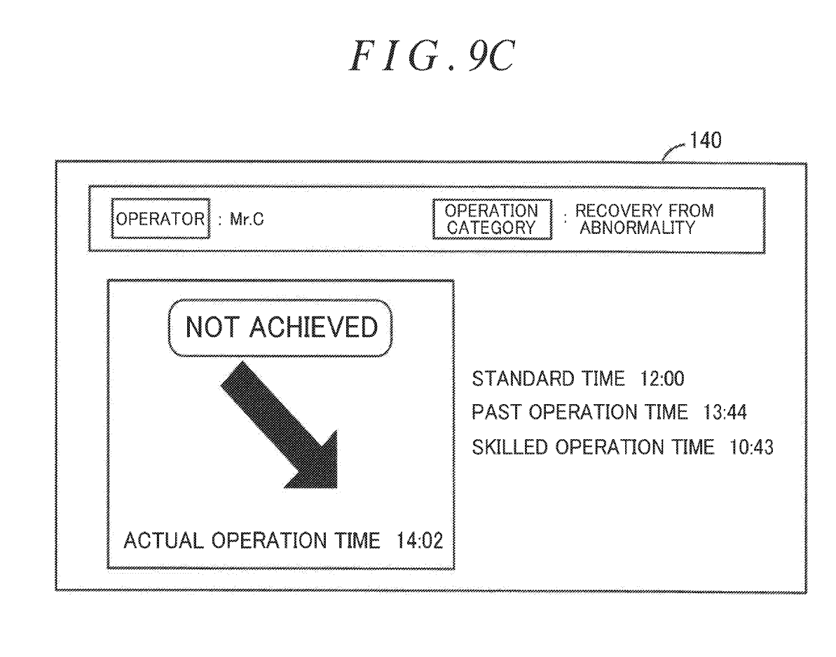

Next, the training assistance apparatus E is described with reference to FIG. 8, FIG. 9A, and FIG. 9B. As illustrated in FIG. 8, the training assistance apparatus E includes an unskilled operation condition acquiring unit 110, a skilled operation time storing unit 120, a standard time storing unit 130, and a display unit 140.

The unskilled operation condition acquiring unit 110 includes an actual operation time acquiring unit 111 and a past operation time storing unit 112. The actual operation time acquiring unit 111 acquires, from the ability database 57, an actual operation time of an operation that is executed by an unskilled operator on one of the processing machines MC1 to MC8. When information is newly added to the ability database 57, the actual operation time acquiring unit 111 acquires the actual operation time of the unskilled operator.

The past operation time storing unit 112 stores, for each operator, a past operation result time of an operation that is executed by the unskilled operator on one of the processing machines MC1 to MC8. When a plurality of past operation result times are present, the past operation time storing unit 112 stores a shortest past operation result time for each operator. The past operation time storing unit 112 may store only the shortest past operation result time or top five past operation result times including the shortest past operation result time.

The skilled operation time storing unit 120 stores a skilled operation time of an operation that is executed by a skilled operator. The skilled operator is a specific operator who is set in advance. For example, the skilled operator is an operator who can complete an operation within an operation time that is much shorter than an operation time of a standard operator (standard time). The skilled operator may be an operator who can provide a high operation quality in addition to the short operation time. The skilled operator is set in association with each operation category. When the operation ability of the skilled operator is improved, the skilled operation time storing unit 120 updates the skilled operation time.

The standard time storing unit 130 stores a standard time of an operation for each operation category. The standard time of an operation is a preset operation time of an operator having a standard operation ability. As described above, the standard time of an operation is used for setting the initial process schedule and the updated process schedule illustrated in FIG. 5.

The display unit 140 displays an actual operation time of an unskilled operator, a past operation result time of the unskilled operator, a standard time, and a skilled operation time so that a comparison can be made therebetween. Display contents of the display unit 140 are described with reference to FIG. 9A to FIG. 9C.

FIG. 9A illustrates a first example of the display contents of the display unit 140. An operator's name and an operation category are displayed in an upper pane of a display screen. An actual operation time of the last operation executed by the unskilled operator is displayed in a left pane of the display screen. In FIG. 9A, the actual operation time is 15:31. A standard time of the operation category, a past operation result time of the unskilled operator, and a skilled operation time are displayed in a right pane of the display screen. In FIG. 9A, the standard time is 12:00, the past operation result time is 16:12, and the skilled operation time is 10:43.

The actual operation time in this case is longer than the standard time. Therefore, a phrase “NOT ACHIEVED” is displayed in the left pane of the display screen so as to indicate that the actual operation time has not reached the standard time. Thus, the unskilled operator can easily grasp that the actual operation time has not reached the standard time yet. The actual operation time in this case is shorter than the past operation result time of the unskilled operator. Therefore, an upward arrow is displayed in the left pane of the display screen so as to indicate that the actual operation time is shorter than the past operation result time. Thus, the unskilled operator can easily grasp that the actual operation time is shorter than the past operation result time. Further, the unskilled operator can easily grasp how much difference is present between the actual operation time and the skilled operation time by comparing the actual operation time and the skilled operation time.

FIG. 9B illustrates a second example of the display contents of the display unit 140. In FIG. 9B, the actual operation time of the unskilled operator is shorter than the standard time, and is also shorter than the past operation result time of the unskilled operator. Therefore, a phrase “ACHIEVED” is displayed in the left pane of the display screen so as to indicate that the actual operation time has reached the standard time. Further, an upward arrow is displayed in the left pane of the display screen so as to indicate that the actual operation time is shorter than the past operation result time.

FIG. 9C illustrates a third example of the display contents of the display unit 140. In FIG. 9C, the actual operation time of the unskilled operator is longer than the standard time, and is also longer than the past operation result time of the unskilled operator. Therefore, a phrase “NOT ACHIEVED” is displayed in the left pane of the display screen so as to indicate that the actual operation time has not reached the standard time yet. Further, a downward arrow is displayed in the left pane of the display screen so as to indicate that the actual operation time is longer than the past operation result time of the unskilled operator.

The training assistance apparatus E described above includes the actual operation time acquiring unit 111 configured to acquire an actual operation time of an operation that is executed by an unskilled operator on one of the processing machines MC1 to MC8, the standard time storing unit 130 configured to store a standard time of the operation, and the display unit 140 configured to display the actual operation time and the standard time for comparison. Therefore, the unskilled operator can grasp whether the operation executed by the unskilled operator is standard. The operation result will become a force that motivates the unskilled operator to improve the operation abilities.

The training assistance apparatus E includes the past operation time storing unit 112 configured to store a past operation result time of the operation that is executed by the unskilled operator on one of the processing machines MC1 to MC8. The display unit 140 displays the past operation result time stored in the past operation time storing unit 112 and the actual operation time for comparison. Therefore, the unskilled operator can realize his/her growth by grasping the comparison between the past operation result time of the unskilled operator and the actual operation time that is obtained currently. Thus, the operation result will become a force that motivates the unskilled operator to further improve the operation abilities.

The past operation time storing unit 112 stores a shortest past operation result time when a plurality of past operation result times are present. A comparable past operation result time of the unskilled operator is not the latest time but the shortest time among the past operation result times. The comparison of the actual operation time and the shortest time among the past operation result times will motivate the unskilled operator to further improve the operation abilities.

The training assistance apparatus E includes the skilled operation time storing unit 120 configured to store a skilled operation time of the operation that is executed by a skilled operator. The display unit 140 displays the actual operation time and the skilled operation time for comparison. Therefore, the unskilled operator can grasp a difference between the operation that is executed by the unskilled operator and the operation that is executed by the skilled operator. A comparison result between the operation that is executed by the unskilled operator and the operation that is executed by the skilled operator will become a force that motivates the unskilled operator to further improve the operation abilities.

The skilled operation time storing unit 120 updates the skilled operation time when the operation ability of the skilled operator is improved. Not only the operation ability of the unskilled operator but also the operation ability of the skilled operator is further improved as the skilled operator continues to execute the operation. Therefore, the skilled operation time storing unit 120 updates the stored skilled operation time when the operation ability of the skilled operator is improved. Thus, the target operation time for the unskilled operator can be set at a higher grade. As a result, the operation ability of the unskilled operator can further be improved. In addition, a higher improvement rate can be expected for the operation ability of the unskilled operator.

What is claimed is:

1. A training assistance apparatus, comprising:
an actual operation time acquiring unit configured to acquire an actual operation time of an operation that is executed by an operator on a processing machine;
a standard time storing unit configured to store a standard time of the operation; and
a display unit configured to display the actual operation time and the standard time for comparison.

2. The training assistance apparatus according to claim 1, further comprising:
a past operation time storing unit configured to store a past operation result time of the operation that is executed by the operator on the processing machine, wherein
the display unit is configured to display the past operation result time stored in the past operation time storing unit and the actual operation time for comparison.

3. The training assistance apparatus according to claim 2, wherein
the past operation time storing unit is configured to store a shortest past operation result time when a plurality of past operation result times are present.

4. The training assistance apparatus according to claim 1, further comprising:
a skilled operation time storing unit configured to store a skilled operation time of the operation that is executed by a skilled operator, wherein
the display unit is configured to display the actual operation time and the skilled operation time for comparison.

5. The training assistance apparatus according to claim 4, wherein
the skilled operation time storing unit is configured to update the skilled operation time when an operation ability of the skilled operator is improved.
